(19) United States
(12) Patent Application Publication
(10) Pub. No.: US 2026/0245006 A1
(43) Pub. Date: Aug. 20, 2026

(54) Systems and Methods for Data Record Routing

(71) Applicant: OPTUM, INC., Minnetonka, MN (US)

(72) Inventors: Rahul Bhaskar, Irvine, CA (US); Kartik Kohli, Delhi (IN); Sundeep S Singh, Odisha (IN); P R Anand Krishnan, New Delhi (IN); Vaibhav Kakkar, Irvine, CA (US); Ashutosh Singh, Uttar Pradesh (IN); Saurabh Chaudhary, Haryana (IN)

(21) Appl. No.: 19/056,352

(22) Filed: Feb. 18, 2025

(51) Int. Cl. G06Q 10/0631

(52) U.S. Cl. CPC G06Q 10/063112

(57) ABSTRACT

The disclosed techniques route data records to reviewers in a manner that improves performance metrics (e.g., throughput, accuracy, etc.), and in some embodiments dynamically adapts to changes in a reviewer pool. The techniques segment reviewers into clusters based at least in part on reviewer feature sets (e.g., performance-based review metrics such as accuracy, completeness, and/or variability), and assign labels to the reviewers based on the segmenting. The techniques also generate subject-specific performance indicators (e.g., vectors, scores, etc.) for the reviewers. For a given data record that is to be reviewed, the techniques determine a propensity metric indicating the probability that the data record pertains to a particular subject, and generate a routing decision by applying the propensity metric, subject-specific performance indicators, and label assignments as input to a routing model. The techniques then route the data record to a particular reviewer based at least in part on the routing decision.

### TECHNICAL FIELD

The present disclosure generally relates to techniques for data routing, and more particularly, to techniques for routing data records to reviewers in a manner that improves performance metrics (e.g., throughput, coding accuracy, etc.) and, in some embodiments, dynamically adapts to changes in a reviewer pool.

### BACKGROUND

In many fields, data records are routed to reviewers for various purposes. In the health insurance field, for example, medical records of patients are typically routed to individuals charged with reviewing and coding the records to accurately reflect the health statuses of the patients. Due to the huge number of incoming claims/records, it can be important that reviewers/coders work quickly (i.e., have a high throughput) without unduly sacrificing accuracy/quality. Similar needs exist in other fields as well, such as financial fields where various statements or other data records may need to be audited and coded (classified, flagged, etc.) by reviewers. Conventionally, data records are routed to individuals within an available pool of reviewers in a random manner, according to fixed rules (e.g., X records per reviewer per month), and/or based on reviewer availability. However, this can create substantial inefficiencies that degrade various performance metrics (e.g., throughput, accuracy, completeness, variability across data records, etc.). These inefficiencies can be compounded by changes within the pool of reviewers, such as changing experience and/or ability levels, new reviewers being added to the pool, and so on.

### BRIEF DESCRIPTION OF THE DRAWINGS

The figures described below depict embodiments for purposes of illustration only. One skilled in the art will readily recognize from the following discussion that alternative embodiments of the systems and methods illustrated herein may be employed without departing from the principles of the disclosure described herein. The detailed description is described with reference to the accompanying figures. In the figures, the same reference number appearing in different figures indicates the same element or a similar element.

FIG. 1 depicts an example computing environment in which various embodiments of the present disclosure can be implemented.

FIG. 2 depicts an example data record routing process that may be implemented in the computing environment of FIG. 1.

FIG. 3 depicts an example reviewer labeling process that may be implemented within the data record routing process of FIG. 2.

FIG. 4 depicts example data structures and update operations that may be used in conjunction with the data record routing process of FIG. 2.

FIG. 5 depicts a flow diagram of an example computer-implemented method for routing data records.

### DETAILED DESCRIPTION

As explained above in the Background, conventional data record routing techniques can create substantial inefficiencies that result in degraded performance (e.g., poor throughput, accuracy, completeness, recall, variability across data records, etc.). Systems, methods, processes, etc., of the present disclosure can route data records to particular reviewers in a manner that mitigates these inefficiencies and improves upon such performance metrics. Moreover, in some embodiments, systems, methods, processes, etc., of the present disclosure can dynamically adapt to changes in the reviewer pool (e.g., new reviewers and/or changes in reviewer experience level, abilities, etc., over time) while mitigating adverse impacts to performance.

In particular, techniques of the present disclosure generate routing decisions for data records based on the contents of the data records as well as labels and subject-specific indicators associated with individual reviewers. As used herein, the term “reviewer” may refer to a specific human individual, a specific group of human individuals within a larger group, an artificial intelligence model (e.g., agent) or set of such models that has/have been trained in a particular way to review data records, or any other suitable reviewing entity or subset of reviewing entities within a larger pool of reviewing entities.

More specifically, the disclosed techniques use feature sets of reviewers within a reviewer pool (e.g., metrics and/or other values indicative of accuracy, completeness, throughput, experience level, etc.) to segment those reviewers into clusters, and assign/generate labels to individual reviewers within the pool based on the segmenting/clustering. The disclosed techniques also generate subject-specific performance indicators for the reviewers in the pool using feature sets that relate to subject-specific performance, and that may or may not include one or more features in common with the feature sets that were used for the segmenting/labeling. In a context where the reviewers code medical records, for example, the subject-specific performance indicators may include medical condition-specific labels (e.g., labels specific to hierarchical condition categories (HCCs)), and possibly metrics (scores, etc.) associated with those labels.

For a given data record that is to be routed, the disclosed techniques use a natural language processing (NLP) model to determine a propensity metric (e.g., percentage or score) indicative of the probability that the data record pertains to a particular subject (e.g., particular HCC). In some embodiments, the disclosed techniques use the NLP model (or multiple NLP models) to determine multiple such propensity metrics for multiple respective subjects (e.g., multiple HCCs). The disclosed techniques can then generate a routing decision for the data record by applying the propensity metric(s), the subject-specific performance indicators of the reviewers in the pool, and the label assignments of the reviewers in the pool as input to a routing model. For example, the routing model may seek to maximize or minimize a review throughput function subject to a set of operational constraints. In some embodiments, the review throughput function more heavily weighs subject-specific performance indicators, or more heavily weighs label assignments, as the propensity metric increases or decreases, respectively. In some embodiments where the disclosed techniques select the labels for reviewers from among a prioritized set of labels, the routing model generally functions to route data records to reviewers having higher-priority (e.g., generally better performing) labels, but may instead route a given data record to a reviewer with a lower-priority (e.g., generally worse performing) label if (1) that data record has a high propensity to be associated with a specific subject (e.g., specific HCC) and (2) the reviewer with the inferior label has a better subject-specific performance indicator for that subject. After a routing decision is generated, the disclosed techniques can route the data record accordingly, e.g., by transmitting the data record to a client device of the selected reviewer, or by instructing another computing system to transmit the data record to the client device, etc.

These disclosed techniques can improve upon the review-based performance metrics (e.g., accuracy, completeness, recall, throughput, etc.) provided by conventional techniques, by increasing the probability that a given data record is routed to a reviewer that is capable of accurately (and/or completely, quickly, etc.) reviewing/coding/etc. the data record. The use of segmentation based on reviewer feature sets facilitates routing that favors higher-performing reviewers, while providing flexibility by allowing for some degree of interchangeability (e.g., routing to a different reviewer with the same label if a first reviewer with that label is currently unavailable). Moreover, the joint use of (1) subject-specific performance indicators, and (2) propensity metrics for data records to be routed, can provide a more optimal solution by allowing for a data record to be routed to a reviewer with a lower-performing label if that reviewer is particularly well suited to review the subject of that data record. Thus, the disclosed techniques can advantageously provide a balance of both performance and flexibility.

Moreover, in some embodiments, the disclosed techniques can dynamically adapt to changes in the reviewer pool (e.g., new reviewers and/or changes in reviewer experience levels, abilities, etc., over time) while mitigating adverse impacts upon review performance metrics. In some embodiments, for example, the disclosed techniques use reinforcement learning to update metrics (e.g., scores) associated with the subject-specific performance indicators of reviewers, e.g., based on whether reviewers were able to properly (accurately, completely, etc.) and/or quickly review/code/etc. the data records that were routed to them. As another example, the disclosed techniques may assign labels to new reviewers even in the absence of performance data of the sort that was used to label other reviewers, by using similarity metrics to map the new reviewers to existing labels (e.g., until sufficient performance data is obtained for the new reviewers).

Of course, it should be appreciated that the advantages and technical improvements described above and elsewhere herein are not the only advantages and/or technical improvements that may be realized from the techniques described herein. Other advantages and/or technical improvements to the functioning of a computer itself or other technologies or technical fields may be apparent to one of ordinary skill in the art.

While examples discussed or shown herein refer primarily to the healthcare field (e.g., medical records and medical record reviewers/coders), it is to be understood that the disclosed techniques and embodiments can instead or additionally be applied in connection with other fields and/or applications that involve data record review, such as data record auditing in financial fields, internal audits or other reviews of enterprise data records, and so on.

### EXAMPLE COMPUTING ENVIRONMENT

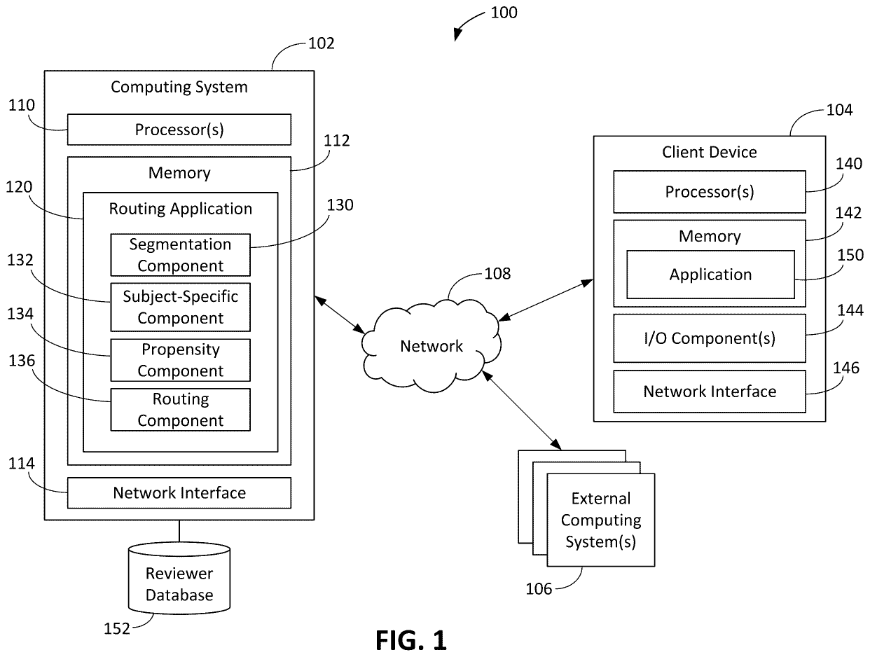

FIG. 1 depicts an example computing environment 100 in which various embodiments of the present disclosure may be implemented. Generally, the example computing environment 100 includes a computing system 102, a client device 104, and a number of external computing systems 106, some or all of which are communicatively coupled via a network 108.

Generally, the client device 104 is associated with a reviewer (e.g., human reviewer) who may be trained/qualified to review data records in a particular field. For example, the reviewer may be trained to review medical records of patients associated with insurance claims, and to code the medical records for claim authorization or other purposes. In some embodiments, the reviewer is trained to code data records according to subject. In the above example, for instance, the reviewer may be trained to code medical records as pertaining to (e.g., as indicating the presence of) particular HCC and/or International Classification of Diseases (ICD) codes. As another example, the reviewer may be trained to flag financial data records according to categories such as “no fraud suspected,” “card skimming,” “identity theft,” and so on. While FIG. 1 shows only a single client device 104, it is understood that the computing environment 100 may include any number of similar client devices associated with different reviewers in a reviewer pool.

The computing system 102 may be associated with an organization that provides a service of routing data records to reviewers for review. In some embodiments, the computing system 102 is associated with an entity that exclusively performs such a service. In other embodiments, the computing system 102 is associated with an entity such as a health insurance payor, or any other suitable entity. The computing system 102 and client device 104 may be associated with the same entity. The computing system 102 may include a single server, or multiple servers that are co-located and/or remotely distributed, for example. In some embodiments, the computing system 102 provides routing services via a cloud platform (e.g., Amazon Web Sevices (AWS)®, Microsoft Azure®, or Google Cloud®).

The computing system 102 includes one or more processors 110, memory 112, and a network interface 114. The processor(s) 110 may include any suitable number of processors and/or processor types. In some examples, the processor(s) 110 include one or more central processing units (CPUs), one or more graphics processing units (GPUs), one or more tensor processing units (TPUs), one or more field-programmable gate arrays (FPGAs), one or more application-specific integrated circuits (ASICs), and/or the like. Generally, the processor(s) 110 comprise hardware configured to execute instructions (e.g., processor-executable code/instructions) stored in the memory 112.

The memory 112 may include any suitable memory type(s), including one or more volatile memories (e.g., dynamic and/or static random-access memory (RAM)) and/or non-volatile memories (e.g., read-only memory (ROM), erasable programmable ROM (EPROM), electrically EROM (EEROM), NAND flash, and/or solid state drive(s) (SSD(s))), all or any of which are examples of non-transitory computer-readable media. In some examples, the memory 112 stores one or more of: an operating system; one or more software components (e.g., firmware, application(s), binary, source code, executable instructions, machine-learned model(s)); transient data and/or code loaded and/or operated on by one or more software component(s); and/or other suitable components/data). In the example computing environment 100, the memory 112 stores the processor-executable instructions of a routing application 120, which includes a segmentation component 130, a subject-specific component 132, a propensity component 134, and a routing component 136.

In some embodiments, the routing application 120 includes more, fewer, and/or different components, and/or the memory 112 may store more, fewer, and/or different components, than what is depicted in FIG. 1. Additionally or alternatively, in some embodiments, some or all of the components that FIG. 1 shows as being stored in memory 112 are instead stored remotely, and are remotely accessed/used by the computing system 102. For example, the computing system 102 may remotely access the functionality of the routing application 120 (or just the functionality of the propensity component 134, etc.) via a cloud service provided by another entity and computing system.

The network interface 114 includes one or more hardware and/or software components that are generally configured to enable the computing system 102 to communicate, via the network 108, with other components and/or devices of the computing environment 100, such as the client device 104 and external computing system(s) 106. To this end, the network interface 114 includes hardware and/or software that operates in accordance with at least one communication protocol of the network 108.

The network 108 includes one or more wired and/or wireless communication networks, such as a cellular network (e.g., 5G®, 4G LTE®, 3G®), a Wi-Fi® network (i.e., an IEEE 802.11 standards network), a microwave access network (e.g., WiMAX®), and/or any other suitable wide area network (WAN), local area network (LAN), personal area network (PAN), etc. As just one example, the network 108 may include both a wireless LAN such as a Wi-Fi® network and a WAN such as the Internet. In some embodiments, the network 108 includes multiple, entirely distinct/parallel networks (e.g., one or more networks for communications between computing system 102 and client device 104, and one or more separate networks for communications between computing system 102 and external computing system(s) 106, etc.).

The client device 104 may be a desktop computer, a laptop computer, a tablet device, a mobile device, a wearable device (e.g., augmented or virtual reality glasses/headsets), or any other suitable computing device. The client device 104 includes one or more processors 140, memory 142, one or more input/output (I/O) components 144, and a network interface 146. The processor(s) 140 may include any suitable number of processors and/or processor types. In some examples, the processor(s) 140 include one or more CPUs, one or more GPUs, one or more TPUs, one or more FPGAs, one or more ASICs, and/or the like. Generally, the processor(s) 140 comprise hardware configured to execute instructions (e.g., processor-executable code/instructions) stored in the memory 142. The memory 142 may include any suitable memory type(s), including one or more volatile memories (e.g., dynamic and/or static RAM) and/or non-volatile memories (e.g., ROM, EPROM, EEROM, NAND flash, and/or SSD(s)), all or any of which are examples of non-transitory computer-readable media. In some examples, the memory 142 stores one or more of: an operating system; one or more software components (e.g., firmware, application(s), binary, source code, executable instructions, machine-learned model(s)); transient data and/or code loaded and/or operated on by one or more software component(s); and/or other suitable components/data). In the example computing environment 100, the memory 142 stores the processor-executable instructions of an application 150, which may be, for example, a web browser application or a dedicated application (e.g., a data record review application offered/provided by an entity associated with computing system 102).

The I/O component(s) 144 include hardware and/or software that generally enables a user of client device 104 (i.e., a reviewer) to interact with the client device 104, e.g., for purposes of reviewing (coding, classifying, etc.) a given data record. The I/O component(s) 144 may include one or more input components that enable a user of client device 104 to enter inputs to the client device 104 (e.g., a keyboard, a microphone, etc.), one or more output components that enable the user to perceive outputs generated by the client device 104 (e.g., a monitor/display, a speaker, a haptic feedback component, etc.), and/or one or more integrated I/O components (e.g., a touchscreen). The I/O component(s) 144 may use any suitable technology or technologies, such as LED, OLED, or LCD display technology, for example. While FIG. 1 shows client device 104 as a single component communicating (via network 108) with the computing system 102, in some implementations the components of client device 104 shown in FIG. 1 are instead divided among two or more client/user-side devices. As just one example, a pair of smart glasses may include one portion of the processor(s) 140, at least a portion of the memory 142, and a display of the I/O component(s) 144, while a smartphone may include another portion of the processor(s) 140, another portion of the memory 142, a touchscreen of the I/O component(s) 144, and the network interface 146. The smart glasses may then communicate as needed with the smartphone (e.g., via Bluetooth®) to enable the operations described herein.

The network interface 146 includes one or more hardware and/or software components that are generally configured to enable the client device 104 to communicate, via the network 108, with other components and/or devices of the computing environment 100, such as the client device 104. To this end, the network interface 146 includes hardware and/or software that operates in accordance with at least one communication protocol of the network 108.

While not explicitly shown in FIG. 1, one, some, or all of the external computing system(s) 106 may have components (e.g., processor(s), memory, network interface, and possibly I/O component(s)) that are generally similar to computing system 102 or client device 104.

The routing application 120 is generally configured to perform various operations that assess (label, classify, etc.) reviewers in a reviewer pool, assess data records that are to be routed, and determine a routing decision based on those assessments. Within routing application 120, segmentation component 130 is generally configured to segment reviewers into clusters based on feature sets associated with the reviewers, and label the reviewers based on the resulting clusters. Subject-specific component 132 is generally configured to generate subject-specific indicators (e.g., labels, metrics, etc.) for the reviewers based on other feature sets (e.g., features indicative of subject-specific performance). Propensity component 134 is generally configured to analyze data records and determine propensity metrics indicative of how likely the data records are to pertain to (indicate the existence of, reflect, etc.) particular subjects (e.g., HCCs, conditions, etc.). Routing component 136 is generally configured to generate routing decisions for routing particular data records to particular reviewers, based on outputs of the segmentation component 130, the subject-specific component 132, and the propensity component 134. Reviewer labels and/or subject-specific indicators, and possibly the reviewer feature sets used to generate those labels and indicators, may be stored in reviewer database 152. While referred to herein as a single database, reviewer database 152 may in some embodiments comprise multiple databases stored in one or more locations. The functionality/operation of routing application 120 and components 132, 134, 136 is discussed below in more detail, according to various embodiments.

External computing system(s) 106 includes one or more servers and/or other computing devices of a data record routing system and may, in some embodiments, be associated with the same organization or other entity that owns and/or maintains computing system 102 and/or client device 104. External computing system(s) 106 is/are generally configured to route/transmit specific data records to specific reviewer client devices (e.g., client device 104 and other, similar client devices) in accordance with the determinations of routing component 136. For example, when routing component 136 determines to route a particular data record to a particular reviewer, routing component 136 may transmit to one of the external computing system(s) 106 (via network interface 114 and network 108) an instruction to route the data record to that reviewer, and the receiving external computing system 106 may in response route/transmit the data record to that reviewer's client device. In other embodiments, routing component 136 (or another component of routing application 120) itself routes/transmits data records to client devices, in which case the computing environment 100 may omit external computing system(s) 106.

### EXAMPLE DATA RECORD ROUTING PROCESSES

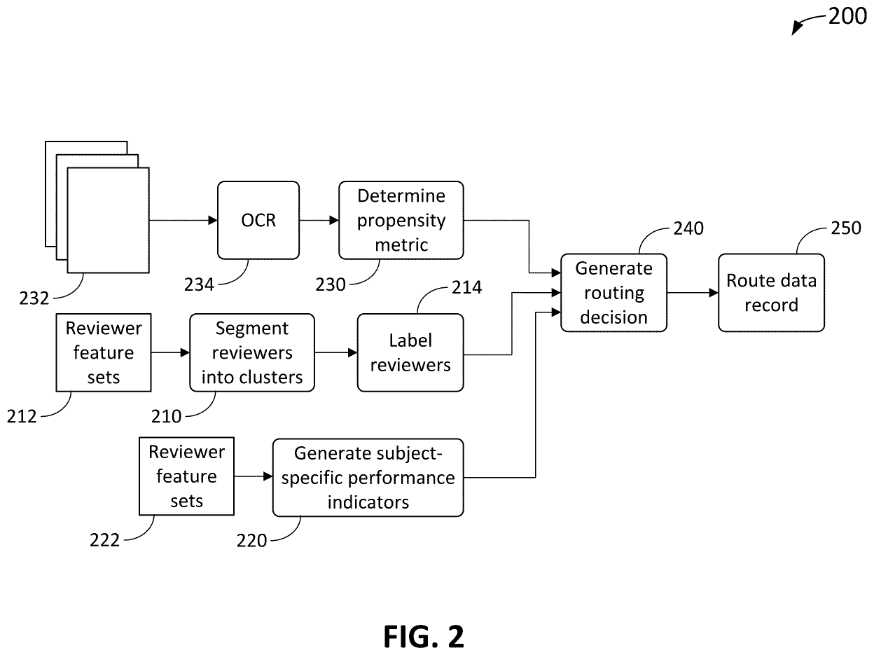

FIG. 2 depicts an example data record routing process 200 that may be implemented in the computing environment 100 of FIG. 1. For ease of explanation, FIG. 2 is described with specific reference to an embodiment in which the process 200 is implemented by the computing system 102, and more specifically by processor(s) 110 when executing instructions of the routing application 120 and its various components.

At stage 210 of the process 200, the segmentation component 130 segments a pool of reviewers into clusters based on feature sets 212 associated with those reviewers. Each of some or all of the feature sets 212 may include one or more features/attributes associated with the respective reviewer. For example, a given reviewer's feature set 212 may include one or more of: (1) a completeness (e.g., recall) metric indicating the reviewer's ability to identify or code all subjects (e.g., HCC or other conditions) that are in fact associated with a given data record; (2) an accuracy metric indicating the reviewer's ability to avoid improperly identifying or coding a given data record; (3) a variability metric indicating the reviewer's consistency in identifying or coding conditions or other subjects (e.g., across multiple data records); (4) a speed metric indicating the reviewer's throughput for reviewing (e.g., coding) data records; and (5) subject-specific performance metric(s) indicating the reviewer's performance (e.g., accuracy, completeness, throughput, variability, etc.) with respect to a specific subject (e.g., a specific HCC). Performance-based metrics such as these may be included in historical performance data collected for the reviewers over time, and may include, for example, scores, percentages, percentiles, and/or other types of metrics.

In some embodiments, a given reviewer's feature set 212 may also (or instead) include one or more experience level-based features, such the reviewer's amount of tenure, education level, certifications, specialties, etc.).

In some embodiments, a given reviewer's feature set 212 includes a number of performance variability metrics with respect to different factors/variables. For example, a feature set 212 may include metrics indicative of performance variability by each of subject (e.g., condition, HCC, etc.), opportunity (e.g., from one data record to the next), speed, tenure, and/or educational profile.

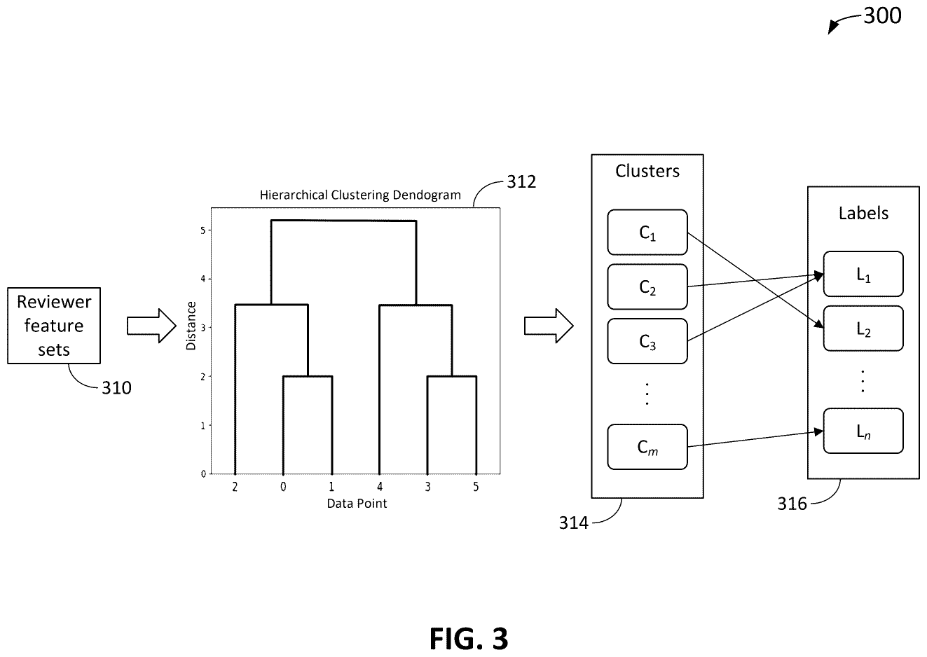

For the segmentation at stage 210, the segmentation component 130 may use any suitable clustering technique to segment the reviewers, such as hierarchical clustering (e.g., Ward or agglomerative clustering), density-based (e.g., DBSCAN) clustering, distribution-based clustering, or centroid-based (e.g., K-means) clustering, for example. Once clustering is complete, at stage 214, the segmentation component 130 uses the resulting cluster associations to assign each of some or all of the segmented reviewers to respective labels. In some embodiments, each of some or all of the clusters is associated with its own distinct label, while in other embodiments the segmentation component 130 can apply a many-to-one mapping for one, some, or all of the clusters. One such example mapping is shown in FIG. 3, which depicts an example reviewer labeling process 300 that may be implemented by the segmentation component 130. In FIG. 3, the segmentation component 130 uses hierarchical clustering based on the reviewer feature sets 310 (which may be the feature sets 212 of FIG. 2) to segment reviewers into clusters 314, with FIG. 3 schematically representing the clustering process via a hierarchical clustering dendogram 312. While the dendogram 312 shows five resulting data points (clusters), it is understood that, in the depicted scenario, the clustering results in m clusters 314, where m is any suitable integer (e.g., three, five, 10, 100, etc., or possibly, in some scenarios, one). While the clusters 314 are not necessarily associated with explicit labels, the clusters 314 may be associated with particular combinations of attributes. For example, C₁ may generally represent “High Performance Coder, Less Variation in Performance, Average Speed, High Accuracy for Diabetes, XYZ Certified,” while C₂ may generally represent “High Performance Coder, Moderate Variation in Performance, Average Speed, XYZ Certified,” and so on.

The segmentation component 130 may map the m clusters to n labels 316, where n is any suitable integer greater than zero and less than or equal to m. The segmentation component 130 assigns the reviewers to particular labels based on the clusters 314 into which the reviewers were segmented and the mappings of those clusters 314 to specific labels. In the depicted embodiment and scenario, for example, the segmentation component 130 assigns label L₂ to reviewers in cluster C₁, assigns label L₁ to reviewers in cluster C₂ and reviewers in cluster C₃, and so on.

Returning now to FIG. 2, at stage 220, the subject-specific component 132 generates one or more subject-specific indicators for each of some or all of the reviewers in the pool based on feature sets 222 associated with those reviewers. Generally, each of some or all of the feature sets 222 includes one or more features/attributes indicative of subject-specific performance of the respective reviewer. For example, a given reviewer's feature set 222 may be indicative of the reviewer's performance with respect to a particular condition (e.g., a particular HCC). As a more specific example, a given reviewer's feature set 222 may include completeness, accuracy, variability, speed, and/or other performance metrics indicating the reviewer's performance with respect to a specific subject (e.g., a specific HCC). In some embodiments, each feature of some or all of the feature sets 222 also includes one or more features/attributes indicative of experience level with respect to one or more particular conditions (e.g., a degree of training for coding a particular HCC). The feature sets 222 may be subsets of the feature sets 212, overlap with the feature sets 212, or be entirely distinct from the feature sets 212.

The subject-specific performance indicators may include labels, vectors, metrics (e.g., scores), and/or other indicators of subject-specific performance. In some embodiments, the subject-specific component 132 directly uses one or more metrics from the feature sets 222 as the indicators. In another embodiment, the subject-specific component 132 computes a subject-specific metric as a function of one or more metrics within the feature sets 222. In still another embodiment, the subject-specific performance indicators include labels, and the subject-specific component 132 uses a clustering technique and a mapping to assign the reviewers to subject-specific labels (e.g., using techniques similar to those discussed above in connection with stage 210).

The routing application 120 may store the label assignments generated at stage 214 and the subject-specific performance indicators generated at stage 220, along with metadata indicating the associations of those labels/indicators with particular reviewers, in the reviewer database 152.

At stage 230, the propensity component 134 determines a propensity metric for a data record 232 using an NLP model. The propensity metric is indicative of a probability that the data record 232 pertains to a particular subject (e.g., relates to, indicates, or reflects the existence of a particular HCC or condition). Any suitable NLP model may be used. For example, the propensity component 134 may determine the propensity metric by applying the data record 232 as input to one or more generative machine-learned model component(s), such as a transformer-based machine-learned model (e.g., a large-language model model (LLM), an embedding model, a diffusion model, and/or the like), and may additionally or alternatively comprise other machine-learned model component(s), such as neural network(s), decision tree(s), and/or the like. In some examples, the NLP model is trained to use text as input or, in other embodiments, may be a multimodal LLM that operates upon text and also other types of content that may be in data records (e.g., images, audio, etc.). The NLP model may receive a text prompt (referred to herein at times as simply a “prompt”) as an input, process the text prompt, and output a propensity metric or metrics responsive to the text prompt. The NLP model may have a transformer-based model architecture that comprises an encoder that tokenizes the input and determines embeddings for the tokens, and a decoder that generates the output based at least in part on the embeddings. The transformer model may incorporate self-attention and/or cross-attention mechanisms to facilitate more accurate output. In some embodiments, such a transformer-based machine-learned model may include different configurations of self- and/or cross-attention, followed by neural network(s) (e.g., feedforward layer(s)), recurrent layer(s), aggregation layer(s) (e.g., using softmax, matrix multiplication, and/or other aggregation techniques), and/or the like. The NLP model may be a general-purpose model (e.g., trained on a wide array of publicly available datasets such as web pages, documents, etc., available via the Internet) such as a generative pre-trained transformer (GPT) 3.5, bi-directional encoder representations from transformers (BERT), or may be a domain-specific model (e.g., trained and/or fine-tuned on custom and/or proprietary datasets), such as a general purpose LLM trained using datasets of data records labeled as pertaining to particular subjects.

In other embodiments, other types of NLP models may be used. For example, the propensity component 134 may apply a rule-based NLP model and/or a statistical model. The NLP model may perform any suitable operations, such as tokenization, named entity recognition, and/or other operations. In some embodiments and/or scenarios, at a stage 234 preceding stage 230, the propensity component 134 (or another component of routing application 120, another application of computing system 102, or another computing system or device) converts the data record 232 to machine-readable text using optical character recognition (OCR) and/or other suitable technique(s). In some embodiments and/or scenarios, however, the routing application 120 receives the data record 232 in machine-readable format, and no conversion is required (e.g., stage 234 may be omitted from the process 200).

The propensity metric may be a confidence score, percentage, or other indicator of the probability that the data record 232 pertains to a particular subject. In some embodiments, for a given/single data record 232, the propensity component 134 determines a separate propensity metric for each of a plurality of subjects (e.g., using a separate NLP model for each subject, or using a single NLP model, etc.). For example, the propensity component 134 may determine that the data record 232 is 72% likely to pertain to a first HCC, 34% likely to pertain to a second HCC, and 11% likely to pertain to a third HCC.

The relative timing of stages 230, 210, 214, and 220 may vary depending on the embodiment. In some embodiments, for example, stages 210, 214, and 220 occur “offline” at an earlier time, while stage 230 (and possibly 234) occur in run-time operation when data record 232 is newly received or otherwise selected for routing. In another embodiment, stages 210, 214, and 220 occur at generally the same time as stage 230 (e.g., in parallel, or shortly before or after), to ensure that the reviewer labels and subject-specific performance indicators accurately reflect the current state of the reviewer pool.

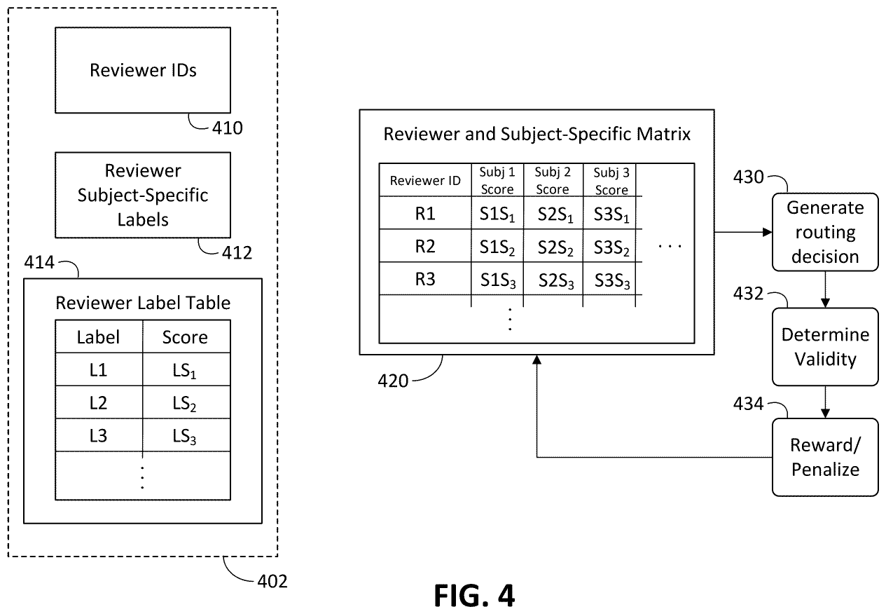

At stage 240, the routing component 136 generates a routing decision (i.e., a selection of a particular reviewer to review the data record 232) by applying the propensity metric(s) from stage 230, the reviewer label assignments from stage 214, and the reviewer subject-specific performance indicators from stage 220 as input to a routing model. Generally, the routing model may seek to optimize the routing of the data record 232, or jointly optimize the routing of multiple data records, with respect to one or more performance-based variables. Application of the routing model may include maximizing or minimizing a review throughput function subject to a set of operational constraints, for example. Operational constraints may include reviewer scheduling/availability and/or workload limits, for example. In some embodiments, the review throughput function more heavily weighs the subject-specific performance indicators (from stage 220) or the label assignments (from stage 214) as the propensity metric (from stage 230) increases or decreases, respectively. In this manner, the routing component 136 may be generally be configured to route the data record 232 to a reviewer having a higher-priority (higher-performing) label, while “overriding” such a routing if a reviewer having a lower-priority (lower-performing) label is particularly well-suited to review the likely subject matter of that particular data record 232 as indicated by the propensity metric. An embodiment in which the propensity component 134 determines multiple propensity metrics for a given data record is discussed in more detail below, in connection with FIG. 4.

After the routing component 136 generates the routing decision, the routing component 136 routes the data record 232 to the selected reviewer at stage 250. Stage 250 may include the routing component 136 transmitting the data record 232, or a link to the data record 232, to a computing device of the selected reviewer (e.g., to client device 104 via network 108). In other embodiments, stage 250 incudes the routing component 136 transmitting (via network 108), to one of external computing system(s) 106, an instruction to send the data record 232 or a link to the data record 232 to a computing device of the selected reviewer. In other embodiments, the routing component 136 uses other suitable techniques or messaging to trigger the provision/availability of the data record 232 to the selected reviewer. The reviewer may then review (e.g., code, classify, flag, etc.) the data record 232 using any suitable software (e.g., application 150).

FIG. 4 depicts example data structures and update operations that may be used in conjunction with the data record routing process 200 of FIG. 2. Reviewer data 402 may be relatively persistent data that includes reviewer identifiers 410, reviewer subject-specific labels 412, and a reviewer label table 414. The reviewer identifiers 410 include respective, unique identifiers for reviewers within a particular reviewer pool (e.g., some or all available reviewers associated with a particular organization). The computing system 102 may maintain the reviewer identifiers 410 by adding identifiers corresponding to new reviewers and removing identifiers corresponding to reviewers who are no longer available. Treatment of new reviewers is discussed in further detail below, according to various embodiments.

The reviewer subject-specific labels 412 may be, or may be a part of, the indicators generated at stage 220 of FIG. 2, and the labels (L₁, L₂, etc.) of the reviewer label table 414 may be the labels available for assignment at stage 214 of FIG. 2, for example. In some embodiments, each of some or all of the identifiers in reviewer identifiers 410 is associated with a particular one of the reviewer subject-specific labels 412 and a particular one of the labels in the reviewer label table 414. In the example embodiment of FIG. 4, each of the labels L₁, L₂, etc., is associated with a particular score (LS₁, LS₂, etc.) that indicates a priority (e.g., overall performance level) of the respective label. Some or all of the reviewer data 402 may be stored in reviewer database 152 and/or updated (e.g., by computing system 102) on a relatively infrequent basis (e.g., a monthly, quarterly, annual, or other periodic basis).

In the depicted embodiment, each of some or all of the reviewer subject-specific labels 412 is converted (e.g., by the subject-specific component 132, during an initialization phase) to a vector having one dimension for each of a number of subjects (e.g., HCCs/conditions/etc.). FIG. 4 depicts the orthogonal components of each such vector as a metric or “score” for a particular subject (e.g., metric/score S1S₁ for a first reviewer R1 with respect to a first subject, metric/score S2S₁ for the first reviewer R1 with respect to a second subject, metric/score S1S₂ for a second reviewer R2 with respect to the first subject, and so on). The set of vectors for the reviewer pool (or at least a portion thereof) forms a reviewer and subject-specific matrix 420. The matrix 420 may also be stored in reviewer database 152, and may be updated (e.g., by computing system 102) on a more frequent basis than reviewer data 402, e.g., using reinforcement learning techniques as discussed further below.

In some embodiments, the routing component 136 generates the routing decision at stage 430 (e.g., stage 240 of FIG. 2) by applying the vectors/scores of the matrix 420, the assigned labels from table 414, and the propensity metric(s) of the data record under consideration as input to the routing model. In one embodiment, for example, the routing model computes, for each of at least some of the reviewers (R1, R2, etc.), a dot product of the reviewer's vector from matrix 420 and a vector formed from the propensity metric(s) of the data record. In an embodiment and/or scenario where the propensity component 134 outputs only a single propensity metric for a given data record (e.g., corresponding to whichever subject results in the highest propensity for that data record), the propensity vector metric may be viewed as a vector having a zero value in all dimensions except the dimension corresponding to a single subject. Conversely, in an embodiment and/or scenario where the propensity component 134 generates multiple propensity metrics for a data record (e.g., corresponding to the X subjects having the highest propensity metrics for that data record, or all subjects having a non-zero propensity metric for that data record, etc.), the propensity vector metric may be a multi-dimensional vector. In either case, the routing component 136 may generate the routing decision by selecting the reviewer having the largest dot product value. In some embodiments, the routing model also operates on one or more additional inputs/factors. For example, the routing model may also consider subject-specific completeness and/or other metrics for each of some or all of the reviewers, in addition to using the vectors of matrix 420 and the reviewer labels from table 414.

In various embodiments, the routing model applied by routing component 136 may balance the use of the reviewer labels from reviewer label table 414 and the vectors from reviewer and subject-specific matrix 420 in different ways. For example, in some embodiments where the routing component 136 computes a dot product for each of some or all reviewers as described above, the routing component selects the reviewer with the greatest dot product value as the routing recipient if that dot product value exceeds a pre-determined threshold value, but otherwise selects a reviewer from the highest-priority label (e.g., L₁, or possibly L₂ or a lower-priority label if required by operational constraints such as reviewer availability) if the dot product value does not exceed the pre-determined threshold value.

FIG. 4 also depicts a feedback mechanism for real-time updating of the reviewer vectors/scores in the matrix 420. Specifically, for at least some of the generated routing decisions, validity of the decision is determined at stage 432. The routing application 120 may determine validity based at least in part on user-provided or other feedback data. For example, after a selected reviewer has acted upon (e.g., coded) a particular data record, a subject matter expert (e.g., a more experienced reviewer) may review those actions and enter an indication of whether the reviewer's actions were valid/correct or invalid/incorrect. In some embodiments, the feedback data also indicates the reason(s) that the reviewer's actions were invalid/incorrect. In any event, the routing application 120 may use a reinforcement learning technique to provide a reward or penalty (at stage 434) based on whether the reviewer's actions were valid or invalid, respectively. The routing application 120 may apply rewards and/or penalties by updating the vector/scores of that reviewer within matrix 420. As just one example, if a data record with a high propensity metric for “Subject 2” was routed to reviewer R3, and feedback data from stage 432 indicates that the reviewer R3 improperly coded the data record (and possibly also indicates that the data record did indeed relate to Subject 2), then the routing application 120 may decrease the metric/score (vector component) S2S₃. The routing component 136 then uses the vectors/scores of the updated matrix 420 to generate a routing decision for the next iteration/data record. In this manner, the routing application 120 can learn to more accurately account for reviewers'actual abilities/performance, while also dynamically adapting to changes in the reviewer pool (e.g., changes in reviewer experience levels, abilities, etc., over time).

In some embodiments, the routing application 120 implements techniques to include relatively new reviewers (e.g., reviewers lacking historical performance data) within the reviewer pool to which data records can be routed. In particular, the routing application 120 may use historical evidence to generate associations between new reviewers and reviewer labels (e.g., labels from reviewer label table 414) using one or more distance-related/association metrics. For example, the routing application 120 may determine the association between a new reviewer and a label by computing a distance metric (e.g., Manhattan distance) based on non-performance reviewer features/attributes of the new reviewer (e.g., educational qualification, technical training, certifications, specializations, etc.) and the corresponding features/attributes associated with the labels. The routing application 120 may then assign to the new reviewer the label with which the reviewer has the closest association based on the distance metric. In some embodiments, however, the routing application 120 excludes the highest-priority and lowest-priority labels from consideration when assigning a label to a new reviewer. Using similarity-based techniques such as those described above, the routing application 120 can dynamically adapt to changes in the reviewer pool resulting from the addition of new reviewers. Moreover, the routing application 120 can apply the reinforcement learning techniques discussed above to refine the matrix 420 vectors/scores for the new reviewers over time (e.g., after initializing the new reviewers'vectors/scores to zero or some other suitable initial value) to help ensure that the new reviewers'abilities, etc., are properly accounted for in future routing decisions.

### EXAMPLE COMPUTER-IMPLEMENTED METHOD

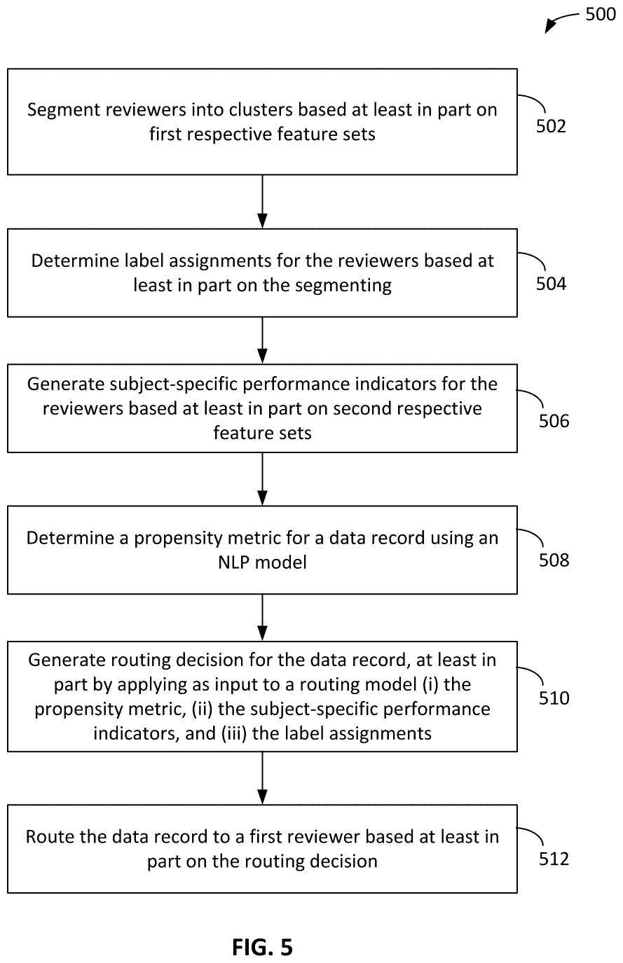

FIG. 5 depicts a flow diagram of an example computer-implemented method 500 for routing data records to reviewers in a manner that improves performance metrics (e.g., throughput, coding accuracy, etc.) and, in some embodiments, dynamically adapts to changes in a reviewer pool. The method 500 may be implemented by processor-executable instructions of routing application 120 when executed by processor(s) 110, for example.

At block 502, a plurality of reviewers is segmented into a plurality of clusters based at least in part on first respective feature sets associated with the plurality of reviewers (e.g., reviewer feature sets 212). At block 504, label assignments for the plurality of reviewers are determined based at least in part on the segmenting of block 502. Blocks 502 and 504 may include any of the operations of segmentation component 130 described above in connection with FIGS. 1-4, for example.

At block 506, subject-specific performance indicators are generated for the plurality of reviewers based at least in part on second respective feature sets associated with the plurality of reviewers (e.g., reviewer feature sets 222). Block 506 may include any of the operations of subject-specific component 132 described above in connection with FIGS. 1-4, for example. In one example embodiment, the subject-specific performance indicators include vectors/metrics (scores) similar to those in the reviewer and subject-specific matrix 420 in FIG. 4.

At block 508, a propensity metric is determined for a data record using an NLP model. The propensity metric is indicative of a probability that the data record pertains to a particular subject. In some embodiments, block 508 includes generating a plurality of propensity metrics each associated with a different subject. Block 508 may include any of the operations of propensity component 134 described above in connection with FIGS. 1-4, for example.

At block 510, a routing decision is generated for the data record, at least in part by applying the propensity metric(s) of block 508, the subject-specific performance indicators of block 506, and the label assignments of block 504 as input to a routing model. Block 510 may correspond to stage 240 of FIG. 2, stage 430 of FIG. 4, and/or any of the routing decision/model operations of routing component 136 described above in connection with FIGS. 1-4, for example. In some embodiments, the routing model directly outputs the routing decision at block 510. In other embodiments, however, one or more additional operations occur at block 510 after the routing model outputs a preliminary routing decision. For example, the routing component 136 (or another component of routing application 120 or a different application) may apply one or more fixed rules or other criteria to generate a final routing decision, such as confirming that a selected reviewer is on-site (e.g., is not on sick leave or vacation) the day that the routing decision is made.

At block 512, the data record is routed to a first reviewer (i.e., a particular reviewer of the reviewer pool) based at least in part on the routing decision of block 510. Block 510 may correspond to stage 250 of FIG. 2, for example.

The method 500 may repeat some or all of blocks 502 through 512 for one or more additional data records. For example, the routing application 120 may repeat blocks 508 through 512 for each of one or more additional data records, repeat blocks 506 through 512 for each of one or more additional data records, or repeat blocks 502 through 512 for each of one or more additional data records, etc.

It is to be understood that the operations of the method 500 may be performed in any suitable order (and/or in parallel), and/or may include fewer, additional, or different operations, in various embodiments.

### EXAMPLES

Example 1. A method comprising: segmenting, by one or more processors, a plurality of reviewers into a plurality of clusters based at least in part on first respective feature sets associated with the plurality of reviewers; determining, by the one or more processors, label assignments for the plurality of reviewers based at least in part on the segmenting; generating, by the one or more processors, subject-specific performance indicators for the plurality of reviewers based at least in part on second respective feature sets associated with the plurality of reviewers; determining, by the one or more processors and using a natural language processing model, a propensity metric for a data record, the propensity metric being indicative of a probability that the data record pertains to a particular subject; generating, by the one or more processors, a routing decision for the data record, at least in part by applying as input to a routing model (i) the propensity metric, (ii) the subject-specific performance indicators, and (iii) the label assignments; and routing, by the one or more processors and based at least in part on the routing decision, the data record to a first reviewer of the plurality of reviewers.

Example 2. The method of Example 1, wherein the first respective feature sets include one or both of a review completeness metric and a review accuracy metric.

Example 3. The method of Example 1, wherein the first respective feature sets include at least one feature indicating variability of review performance.

Example 4. The method of Example 1, wherein the first respective feature sets include at least one feature indicating a review speed metric.

Example 5. The method of Example 1, wherein the first respective feature sets include at least one feature indicating reviewer experience level.

Example 6. The method of Example 1, wherein the first respective feature sets include at least one feature indicating a subject-specific performance metric.

Example 7. The method of Example 1, wherein the second respective feature sets include at least one feature indicating a subject-specific performance metric.

Example 8. The method of Example 1, wherein segmenting the plurality of reviewers into the plurality of clusters includes using a hierarchical clustering technique to determine the plurality of clusters.

Example 9. The method of Example 1, wherein determining the label assignments includes mapping at least a first cluster and a second cluster to a single label.

Example 10. The method of Example 1, wherein generating the routing decision includes maximizing or minimizing a review throughput function subject to a set of operational constraints.

Example 11. The method of Example 10, wherein the review throughput function more heavily weighs the subject-specific performance indicators or the label assignments as the propensity metric increases or decreases, respectively.

Example 12. The method of Example 1, wherein: determining the label assignments includes assigning the plurality of reviewers to respective labels included in a prioritized set of labels; and generating the routing decision includes selecting the first reviewer based at least in part on a priority of a respective label of the first reviewer.

Example 13. The method of Example 1, wherein: generating the subject-specific performance indicators for the plurality of reviewers includes generating sets of subject-specific metrics for the plurality of reviewers; the method comprises determining a plurality of propensity metrics for the data record, the plurality of propensity metrics being indicative of respective probabilities that the data record pertains to a respective subject; and generating the routing decision includes selecting the first reviewer based at least in part on (i) the plurality of propensity metrics, and (ii) the sets of subject-specific metrics for the plurality of reviewers.

Example 14. The method of Example 13, wherein selecting the first reviewer includes selecting the first reviewer based at least in part on (i) the plurality of propensity metrics, (ii) the sets of subject-specific metrics for the plurality of reviewers, and (iii) review completeness metrics of the plurality of reviewers.

Example 15. The method of Example 13, further comprising: receiving, by the one or more processors, feedback data indicating whether the routing decision is valid; and updating, by the one or more processors and based at least in part on the feedback data, at least one of the sets of subject-specific metrics for the plurality of reviewers.

Example 16. The method of Example 1, wherein the particular subject is associated with a particular Hierarchical Subject Category (HCC) code and the subject-specific performance indicators are HCC-specific performance indicators.

Example 17. The method of Example 1, wherein: determining the label assignments includes assigning the plurality of reviewers to respective labels included in a prioritized set of labels; the method further comprises mapping, by the one or more processors, a second reviewer, not included in the plurality of reviewers, to a respective label of the prioritized set of labels based at least in part on a feature set associated with the second reviewer; and generating the routing decision includes applying the respective label of the second reviewer as additional input to the routing model.

Example 18. The method of Example 17, wherein mapping the second reviewer to the respective label of the prioritized set of labels is not based on review performance of the second reviewer.

Example 19. The method of Example 17, wherein mapping the second reviewer to the respective label of the prioritized set of labels includes excluding from consideration a most-prioritized label of the prioritized set of labels and a least-prioritized label of the prioritized set of labels.

Example 20. The method of Example 1, wherein routing the data record to the first reviewer includes instructing, via a network, an external computing system to transmit the data record to a client device associated with the first reviewer, and wherein the external computing system does not include the one or more processors.

Example 21. A system comprising: one or more processors; and one or more memories storing instructions that, when executed by the one or more processors, cause the one or more processors to perform operations comprising: the method of any one of Examples 1-20.

Example 22. One or more non-transitory computer-readable media storing instructions that, when executed by one or more processors, cause the one or more processors to perform operations comprising: the method of any one of Examples 1-20.

### ADDITIONAL CONSIDERATIONS

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., enreviewer-only model(s), enreviewer-dereviewer model(s), dereviewer-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A method comprising:
segmenting, by one or more processors, a plurality of reviewers into a plurality of clusters based at least in part on first respective feature sets associated with the plurality of reviewers;
determining, by the one or more processors, label assignments for the plurality of reviewers based at least in part on the segmenting;
generating, by the one or more processors, subject-specific performance indicators for the plurality of reviewers based at least in part on second respective feature sets associated with the plurality of reviewers;
determining, by the one or more processors and using a natural language processing model, a propensity metric for a data record, the propensity metric being indicative of a probability that the data record pertains to a particular subject;
generating, by the one or more processors, a routing decision for the data record, at least in part by applying as input to a routing model (i) the propensity metric, (ii) the subject-specific performance indicators, and (iii) the label assignments; and
routing, by the one or more processors and based at least in part on the routing decision, the data record to a first reviewer of the plurality of reviewers.

2. The method of claim 1, wherein the first respective feature sets include one or both of a review completeness metric and a review accuracy metric.

3. The method of claim 1, wherein the first respective feature sets include at least one feature indicating variability of review performance.

4. The method of claim 1, wherein the first respective feature sets include at least one feature indicating a review speed metric.

5. The method of claim 1, wherein the first respective feature sets include at least one feature indicating reviewer experience level.

6. The method of claim 1, wherein the first respective feature sets include at least one feature indicating a subject-specific performance metric.

7. The method of claim 1, wherein the second respective feature sets include at least one feature indicating a subject-specific performance metric.

8. The method of claim 1, wherein segmenting the plurality of reviewers into the plurality of clusters includes using a hierarchical clustering technique to determine the plurality of clusters.

9. The method of claim 1, wherein determining the label assignments includes mapping at least a first cluster and a second cluster to a single label.

10. The method of claim 1, wherein generating the routing decision includes maximizing or minimizing a review throughput function subject to a set of operational constraints.

11. The method of claim 10, wherein the review throughput function more heavily weighs the subject-specific performance indicators or the label assignments as the propensity metric increases or decreases, respectively.

12. The method of claim 1, wherein:
determining the label assignments includes assigning the plurality of reviewers to respective labels included in a prioritized set of labels; and
generating the routing decision includes selecting the first reviewer based at least in part on a priority of a respective label of the first reviewer.

13. The method of claim 1, wherein:
generating the subject-specific performance indicators for the plurality of reviewers includes generating sets of subject-specific metrics for the plurality of reviewers;
the method comprises determining a plurality of propensity metrics for the data record, the plurality of propensity metrics being indicative of respective probabilities that the data record pertains to a respective subject; and
generating the routing decision includes selecting the first reviewer based at least in part on (i) the plurality of propensity metrics, and (ii) the sets of subject-specific metrics for the plurality of reviewers.

14. The method of claim 13, wherein selecting the first reviewer includes selecting the first reviewer based at least in part on (i) the plurality of propensity metrics, (ii) the sets of subject-specific metrics for the plurality of reviewers, and (iii) review completeness metrics of the plurality of reviewers.

15. The method of claim 13, further comprising:
receiving, by the one or more processors, feedback data indicating whether the routing decision is valid; and
updating, by the one or more processors and based at least in part on the feedback data, at least one of the sets of subject-specific metrics for the plurality of reviewers.

16. The method of claim 1, wherein the particular subject is associated with a particular Hierarchical Subject Category (HCC) code and the subject-specific performance indicators are HCC-specific performance indicators.

17. The method of claim 1, wherein:
determining the label assignments includes assigning the plurality of reviewers to respective labels included in a prioritized set of labels;
the method further comprises mapping, by the one or more processors, a second reviewer, not included in the plurality of reviewers, to a respective label of the prioritized set of labels based at least in part on a feature set associated with the second reviewer; and
generating the routing decision includes applying the respective label of the second reviewer as additional input to the routing model.

18. The method of claim 17, wherein mapping the second reviewer to the respective label of the prioritized set of labels is not based on review performance of the second reviewer.

19. A system comprising:
one or more processors; and
one or more memories storing processor-executable instructions that, when executed by the one or more processors, cause the one or more processors to perform operations comprising:
segmenting a plurality of reviewers into a plurality of clusters based at least in part on first respective feature sets associated with the plurality of reviewers;
determining label assignments for the plurality of reviewers based at least in part on the segmenting;
generating subject-specific performance indicators for the plurality of reviewers based at least in part on second respective feature sets associated with the plurality of reviewers;
determining, using a natural language processing model, a propensity metric for a data record, the propensity metric being indicative of a probability that the data record pertains to a particular subject;
generating a routing decision for the data record, at least in part by applying as input to a routing model (i) the propensity metric, (ii) the subject-specific performance indicators, and (iii) the label assignments; and
routing, based at least in part on the routing decision, the data record to a first reviewer of the plurality of reviewers.

20. One or more non-transitory, computer-readable media storing processor-executable instructions that, when executed by one or more processors, cause the one or more processors to perform operations comprising:
segmenting a plurality of reviewers into a plurality of clusters based at least in part on first respective feature sets associated with the plurality of reviewers;
determining label assignments for the plurality of reviewers based at least in part on the segmenting;
generating subject-specific performance indicators for the plurality of reviewers based at least in part on second respective feature sets associated with the plurality of reviewers;
determining, using a natural language processing model, a propensity metric for a data record, the propensity metric being indicative of a probability that the data record pertains to a particular subject;
generating a routing decision for the data record, at least in part by applying as input to a routing model (i) the propensity metric, (ii) the subject-specific performance indicators, and (iii) the label assignments; and
routing, based at least in part on the routing decision, the data record to a first reviewer of the plurality of reviewers.
